(19) United States
(12) Patent Application Publication
(10) Pub. No.: US 2011/0216757 A1
(43) Pub. Date: Sep. 8, 2011

(54) Apparatus and Method for Decentralized Synchronization

(76) Inventor: Juergen Michel, Munich (DE)

(21) Appl. No.: 13/127,787

(22) PCT Filed: Nov. 6, 2008
(86) PCT No.: PCT/EP08/65060

§ 371 Date: May 5, 2011

(51) Int. Cl. H04W 56/00

(52) U.S. Cl. 370/350

(57) ABSTRACT

A base station apparatus may be provided, which may include a synchronization device for generating a synchronization measure, wherein the synchronization measure can represent a quality measure of synchronization for the base station apparatus and wherein the base station apparatus may include a sending device for sending the synchronization measure to further devices.

### TECHNICAL FIELD OF THE INVENTION

The present invention relates to networks, for example to telecommunication networks. In particular the present invention relates to a base station apparatus, a user equipment apparatus, a server apparatus and a method for synchronization.

### BACKGROUND OF THE INVENTION

Synchronization may be known in telecommunication networks. For example base stations in a wireless cellular telecommunication network may be synchronized in relation to each other. The base stations may be synchronized in several procedural steps to mitigate the effect of interference of transmissions from different cells of a network. An interference may occur, when for example two base stations which may be located in the neighborhood to each other, may be sending the same signal, but not synchronized in time. In such a case this signal may be received by a user equipment timely shifted.

The document 3GPP TS 36.423, Version 8.3.0 (2008-09) “Third Generation Partnership Project: Technical Specification Group Radio Access Network; Evolved Universal Radio Access Network (E-UTRAN); X2 application protocol (X2AP), Release 8” may describe technical specifications of radio network procedures.

The document 3GPP TS 36.211, Version 8.4.0 (2008-09) “Third Generation Partnership Project: Technical Specification Group Radio Access Network; Evolved Universal Radio Access Network (E-UTRAN); Physical Channels and Modulation, Release 8” may describe technical specifications of physical channels.

Decentralized synchronization methods are known.

A decentralized synchronization methods is described in WO99/30519. In order to synchronize a base station, a terminal may measure a timing difference between a reference signal transmitted by a base station not communicating with the terminal and one or more reference signals transmitted from base stations communicating with the terminal. The terminal may report the measured difference to the one or more base stations communicating with the terminal. On the basis of the measured time difference, the one or more base stations may be arranged to adjust the timing of the signals they have transmitted to the terminal in relation to each other.

A further decentralized synchronization method is described in the article of “Decentralized Slot Synchronization In Highly Dynamic Ad Hoc Networks” by Ebner A., Rohling H., Lott M. and Halfmann R., 5 th International Symposium of Wireless Personal Multimedia Communications WPMC 2002, Honolulu, Hi., October 2002. This article describes one approach to achieve a locally common slot timing by a mutual adaptation of an individual slot timing. In a first step the slot timing of a received burst may be acquired in form of a one-shot synchronization. In a second step, the own slot timing may be adapted according to the observed difference to a node that transmitted the respective burst.

A disadvantage of the known decentralized synchronization methods may occur when an overall network may be synchronized and a new base station may be added. In such a situation the overall network or at least a large area around the new network node may go into an instable synchronization state before eventually again converging into a stable synchronization state.

There may be a need to provide improved apparatuses and improved methods.

### SUMMARY OF THE INVENTION

According to an exemplary embodiment a base station apparatus, a user equipment apparatus, a server apparatus and a method for synchronization may be provided.

The synchronization of transmissions may be used in TDD (Time Division Duplex) systems where neighboring base stations may use the same frame structure. Furthermore the synchronization of transmissions may be also used in FDD (Frequency Division Duplex) single frequency network systems, like enhanced LTE (enhanced Long Term Evolution) or LTE (Long Term Evolution Advanced)-A MBMS (Multimedia Broadcast and Messaging System) transmission. Moreover the synchronization of transmissions may also be used in mixed FDD/TDD systems, also when introducing relays and inter cell interference coordination in the time domain.

An interference may occur, when for example two base stations which may be located in the neighborhood to each other, may be sending the same signal, but not synchronized in time. In such a case this signal may be received by a user equipment timely shifted. The time shifting may disturb the functionality of the user equipment if time shift can not be corrected (reversed) in the signal processing chain of the user equipment.

A synchronization may also be performed with a user equipment apparatus. A user equipment apparatus may be for example a mobile device, a mobile user equipment, a mobile station, a mobile terminal or a mobile telephone.

In mobile communication systems different levels of synchronicity may be distinguished. These synchronization levels may be slot, sub-frame or frame synchronization. For a TDD system mainly two levels of synchronicity may be considered, which may be the frame or sub-frame synchronization and the UL (UpLink)/DL (DownLink) switching point synchronization.

The frame synchronicity may be strived for in any cellular or broadcast system. In frame synchronization it may be assumed that neighboring cells may use the same frame length. In this context, a frame may be understood as a period of a basic repetitive structure of uplink/downlink (UL/DL) periods and broadcast channels or physical signals. UL (UpLink)/DL (DownLink) switching point synchronization may be specific for TDD. In TDD systems it may be assumed that in addition to frame synchronicity, the UL/DL switching points are aligned. In both cases of frame synchronization and of UL/DL switching point synchronization, synchronicity may cover neighboring co-channel and/or neighboring adjacent channel cells.

Co-channel cells may be defined as geographical neighbors using the same frequency band. The base stations have a geographical inter site distance (ISD) and may substantially not have additional separation. Adjacent channel cells may be frequency neighbors. The base stations may be co-located such that the base stations may substantially only be separated by a distance. In the frequency domain, there may be protection from band selection filters both at a transmitter and a receiver.

When networks of different operators may be provided, a backhaul may need to be synchronized. Therefore a frame synchronization method may be used, which may be self organized over-the-air synchronization. Correspondingly the switching point may be either be fixed, or only partially synchronized over the air.

In networks static synchronization classes may be assigned to terminal nodes in a device to device communication. This may be used e.g. to enable GPS equipped communication nodes to indicate that these nodes have absolute time reference available.

The static synchronization classes may be utilized if a network may be built of base stations partly equipped with GPS receivers. Then the base stations with GPS receivers may be time synchronized by GPS and the ones without GPS receivers may achieve synchronization. This may be provided e.g. by decentralized over the air synchronization by adopting the synchronization state from the GPS synchronized network nodes.

According to an exemplary embodiment of the present invention a base station apparatus may be provided, which may comprise a synchronization device for generating a synchronization measure, wherein the synchronization measure represents a quality measure of synchronization for the base station apparatus and wherein the base station apparatus may comprise a sending device for sending the synchronization measure to further devices.

The synchronization measure may allow comparing a degree of synchronization between at least two base station apparatuses.

A base station apparatus may provide different services for further apparatuses and/or for further devices in a network, for example in a telecommunication network. In order to be coordinated with further apparatuses and/or devices the base station apparatus may be equipped with a synchronization device. With this synchronization device the base station may provide a synchronization measure. This synchronization measure may be a characteristic of the base station apparatus. The synchronization measure may represent a quality measure in relation to at least one other apparatus, for example one other base station. In order to communicate this characteristic to one or more neighbor base station apparatuses, to a user equipment apparatus, to a server apparatus or to a broadcast channel, the base station apparatus may comprise a sending unit. When a station apparatus may comprise a sending unit for other purposes, the same sending device may also be utilized for synchronization purpose. Therefore, the base station apparatus may communicate by sending the synchronization measure to other apparatus and/or devices in the telecommunication network over air or by cable. To communicate the synchronization measure may substantially help avoiding unstable situations in the network.

According to another exemplary embodiment of the invention in relation to the base station apparatus, it may be provided that the synchronization measure may be at least one value selected from the group of values consisting of a time duration value, an on time value, an absolute value, a relative value and a normalized value.

An on-time value may be for example the time duration of service of the base station apparatus counted from the last restart after an interruption of service of the base station apparatus. Thus, the on-time may be a measure for the time, a base station apparatus may achieve. The operation time may indirectly represent the quality of synchronization of the base station apparatus, since several synchronization procedures may be conducted during the operation time of the base station apparatus.

In an example, a longer operation time may represent a high quality of synchronization, since after each synchronization procedure the synchronization quality to neighbor base station apparatus may improve.

A time duration value may also be suitable, which may be for example an observed time span during the operation of the base station apparatus.

An absolute synchronization value may also be utilized, which may be for example a numeral value representing the on-time of the base station apparatus. In other words, for example a numeral of 10 may represent a longer operation time than a numeral value of 1, which may represent a shorter operation time.

A relative value may represent for example also further synchronization measures of other base station apparatus in the network.

In another example, a normalized value may be provided in order to compare different synchronization measures of different base stations. A normalized value may be a value related to a common basis for all base stations. A normalized value may allow comparing different synchronization values. This may simplify the comparison between different base station apparatus. Thus, the different base station apparatus may be directly comparable in respect to their synchronization status. Then a ranking of the different base station apparatus may be possible, which may also be used to classify the different base station apparatus in different synchronization classes. A normalized value may be utilized as well for the synchronization measure, wherein for example a scaling may be performed in relation to other factors to be taken into account when evaluating a synchronization measure, such factors may be for example the surrounding temperature which may cause a drifting transmission signal.

According to an exemplary embodiment of the invention, the base station may comprise a receiving unit for receiving a time adjustment value, wherein the time synchronization value may be determinable from the received time adjustment value.

A receiving device may be a separate device of the base station apparatus or may also be integrated in the sending device of the base station apparatus. A combined sending and receiving device may save space and therefore the base station apparatus may be reduced in size. A time adjustment value may be sent from a user equipment apparatus, which may compare two or more base stations in respect to their frame timing, their sub-frame timing or their slot timing. With the help of the synchronization device of the base station apparatus a synchronization measure may be determined. The base station apparatus may receive a time difference representing the status of non-synchronization of the base station apparatus and the compared neighbor base station apparatus.

Based on this time difference as a time adjustment value the base station apparatus may determine its own synchronization measure. In the case the time difference may be low, the base station apparatus may determine a synchronization measure representing a high quality of synchronization. In the case the time difference may be high, the base station apparatus may determine a synchronization measure representing a low quality of synchronization.

According to an exemplary embodiment of the invention, the base station apparatus may comprise a threshold value.

This threshold value may be utilized in order to evaluate a synchronization measure performed for example by the synchronization device of the base station apparatus. Such a threshold value may be used in order to classify different events at or inside the base station apparatus. For example there may be a threshold value in relation to a received frame timing, sub-frame timing or slot timing sent for example by an user equipment. Before receiving this timing the base station apparatus may comprise a low synchronization quality which may be represented in a low synchronization measure. After performing a frame shifting of a certain threshold value, wherein the threshold value may be measured in micro seconds for example, the base station apparatus may increase its synchronization measure.

According to an exemplary embodiment of the invention, the synchronization measure may be exchangeable between the base station apparatus and a further apparatus in the network.

With the receiving device the base station may not only be able to send its own synchronization measures to other apparatus and/or devices but may also receive synchronization measures of other apparatus and/or devices. The further apparatus may be one or more base stations, a server apparatus, a user equipment, a node or other devices installed in the communication network. This may provide a more efficient synchronization process, since such a base station apparatus may send its synchronization measure to a neighbor base station apparatus and may receive a further synchronization measure from a neighbor base station apparatus. Such an exchange of synchronization measures may improve the synchronization procedure.

Utilizing the synchronization device of the base station apparatus may allow providing a faster adaptation to the neighbor base stations. If the neighbor base station apparatus does the same, then synchronization between both base station apparatus may be performed within a small time span. The synchronization measure may also be understood as a dynamic synchronization class, since it may classify the base station apparatus in comparison to other base station apparatus within the telecommunication network. The synchronization measure may also be a dynamic means, since it may be time dependent and may therefore change in time. In order to provide a stable synchronization the synchronization measure may be timely or chronologically exchanged, for example periodically, on demand of the other base station apparatus or after a change of synchronization measure may have occurred.

The interface for exchanging information between two base stations may be a standardized X2 interface.

According to an exemplary embodiment of the invention, the base station apparatus may provide an information element comprising the synchronization measure.

The information element may be a part of a message sent by the base station apparatus using the air or using a cable. In the case a cable interface may be used, a X2 signaling may be provided. The X2 signaling of the synchronization measure, may be organized in an application protocol message. Therefore an information element (IE) may be introduced.

According to an exemplary embodiment of the present invention a user equipment apparatus may be provided, which may comprise a receiving device for receiving a first signal from a first device and a second signal from a second device, an evaluation device for evaluating a time difference value between the first signal and the second signal, a sending device for sending the time difference value to an apparatus and wherein the time difference value may allow to determine a synchronization measure of the apparatus.

In an example, the user equipment may be a telephone, especially a mobile phone. The user equipment may be utilized to measure a time difference in relation to frames, sub-frames or slots of two different base station apparatus. It may be possible that the first device may be different from the apparatus and may also not be a part of the apparatus. It may be possible as well that the second device is different from the apparatus and is also not a part of the apparatus.

As an example, the first base station apparatus as a first device may send the first signal and a second base station apparatus as a second device may send the second signal. These signals may be for example LTE PSS (Primary Synchronization Signal). These signals may also be SSS (Secondary Synchronization Signal). With the evaluation device of the user equipment the time difference of the two received signals may be evaluated, for example by a correlation. The result of this evaluation may be utilized in order to determine a synchronization measure of the first base station apparatus and/or the second base station apparatus.

It may be possible to prepare the evaluation result of the user equipment in order to be useable in the synchronization device of the base station apparatus. In such a case after performing the evaluation the user equipment may send the result of the evaluation to the first base station apparatus and/or to the second base station apparatus. From these signals different synchronization measures may be calculated in the base station apparatus.

According to an exemplary embodiment of the invention in relation to the user equipment, the evaluation device may provide the synchronization measure.

The determination of the synchronization measure may be performed by the user equipment and the synchronization measure may be sent afterwards to the first base station apparatus and/or second base station apparatus, respectively. It may also be of advantage to send the synchronization measure of the first base station apparatus to the second base station apparatus and the synchronization measure of the second base station to the first base station apparatus. This may support an effective synchronization procedure of the first and the second base station apparatus to each other. Then it may be possible that the first base station apparatus performs its synchronization towards the second base station apparatus and at the same time the second base station performs its synchronization towards the first base station apparatus. In such a case it may also be possible to utilize only the synchronization measure of both base station apparatus for signaling instead of sending a time difference to initiate a synchronization procedure at the different base station apparatus.

According to an exemplary embodiment of the invention, the user equipment may comprise a threshold value.

A threshold value may be set and only if the synchronization measure of the base station or the base station synchronization class is higher than the threshold value, it is considered in the timing difference measurement performed by the user equipment. This may avoid further traffic of signals in the network. Using a threshold value there may take place a selection of already well synchronized base station apparatus with a high synchronization quality. For example a new base station which may not be synchronized and which should be included in the network for operation, may select such a base station apparatus which may comprise for example at least a certain threshold value.

According to an exemplary embodiment of the present invention a server apparatus may be provided, which may comprise a storage device for storing a first synchronization measure and a second synchronization measure, wherein the first synchronization measure may be stored in relation to a first identification of a first apparatus and wherein the second synchronization measure may be stored in relation to a second identification of a second apparatus.

The first apparatus may be a first base station apparatus and the second apparatus may be a second base station apparatus. There may be provided a table for the storage of the information in relation to the synchronization measure and the identification of a respective apparatus.

According to an exemplary embodiment of the invention the server apparatus may be a self organizing enabled network (SON) server apparatus.

The storage device of the server may store the dynamic synchronisation measures together with a unique base station identification and may be requested via signalling between the SON server and base stations. The signalling of the synchronization measure, meaning the synchronisation stability information, may be standardized part of an interface protocol in the network, especially if it is under control of a SON server.

The invention may also be used for LTE eNodeB (enhanced NodeB) which is the terminology for a base station in LTE. As a result the invention may improve SON and time synchronisation stability.

According to an exemplary embodiment of the invention in relation to the server apparatus, the first synchronization measure and the second synchronization measure may be timely updated.

A dynamic synchronization measure may be present when the synchronization measure is compared to a former synchronization measure determined for the same apparatus but timely before the present synchronization measure. In the case the synchronization measure is different after a certain time compared to the former synchronization measure of the same apparatus, then the synchronization measure may be a dynamic synchronization measure. The time span between the comparisons may be determined. This may improve the synchronization process when the synchronization measures of the different apparatus may be updated periodically. Updating may be performed by overwriting the former synchronization measure by the current synchronization measure of one apparatus. In this case the server apparatus may be able to provide the current synchronization measures of the whole network. If a new base station may be inserted in the network, because of interruption of its service before or because it may be new installed in the network, then this base station apparatus may send a request to the server apparatus in order to choose a base station apparatus of the network which has high synchronization quality represented in the synchronization measure.

According to an exemplary embodiment of the present invention a method may be provided for synchronizing a non-synchronized apparatus with a first apparatus and a second apparatus in a communication network, wherein the method may comprise the steps of receiving a first synchronization measure from the first apparatus, receiving a second synchronization measure form the second apparatus, comparing the first synchronization measure with the second synchronization measure, selecting at least one measure from the group of measures consisting of the first synchronization measure and the second synchronization measure such that the selected synchronization measure represents the highest quality of synchronization of the first synchronization measure and the second synchronization measure and synchronizing the non-synchronized apparatus with that apparatus representing the highest quality of synchronization.

This method may be performed by a non-synchronized base station apparatus which has to be included in the service of the network. It may also be possible, that a non-synchronized base station communicates with a user equipments which user equipment may perform this method for the non-synchronized base station. The user equipment may send an identification of that base station apparatus with the highest quality found by the user equipment. This may be of advantage, since a user equipment, such as a mobile, may have an overview over a greater area of the network than a single base station apparatus.

It may also be possible that a server apparatus performs the suggested method. A server apparatus may provide an overview of the current available synchronization measures in the network. Then the server apparatus may choose one suitable base station apparatus for the new base station apparatus, which is not synchronized so far, in order to start a synchronization procedure. The advantage of the method, independent which apparatus or device may perform this method, is that only one reference base station may be chosen in order to synchronize a non-synchronized base station apparatus. The reference base station apparatus with a high quality of synchronization may not change its own synchronization value during the synchronization procedure of the non-synchronized base station apparatus.

According to an exemplary embodiment of the invention in relation to the method, the method may further comprise broadcasting at least one measure selected from the group of measures consisting of the first synchronization measure, the second synchronization measure and a third synchronization measure.

The synchronization measure, which may be a dynamic synchronisation status of a base station and/or at least a dynamic synchronisation status of a neighbour base station, may be broadcast on a LTE or on a LTE-A broadcast control channel or on a dynamic broadcast control channel. With this information user equipments then may prefer—when selecting neighbour base stations for timing difference measurement—those with already high synchronisation stability. A third synchronization measure may be a synchronization measure of a third base station. This third synchronization measure, which may be a further synchronization measure, may be available by broadcasting.

It has also to be noted that exemplary embodiments of the present invention and aspects of the invention have been described with reference to different subject-matters. In particular, some embodiments have been described with reference to apparatus type claims whereas other embodiments have been described with reference to method type claims. However, a person skilled in the art will gather from the above and the following description that unless other notified in addition to any combination between features belonging to one type of subject-matter also any combination between features relating to different subject-matters in particular between features of the apparatus claims and the features of the method claims may be considered to be disclosed with this application.

These and other aspects of the present invention will become apparent from and elucidated with reference to the embodiments described hereinafter.

Exemplary embodiments of the present invention will be described in the following with reference to the following drawings.

### BRIEF DESCRIPTION OF THE DRAWINGS

FIG. 1 shows a block diagram of a base station apparatus according to an exemplary embodiment of the present invention.

FIG. 2 shows a block diagram of a user equipment apparatus according to an exemplary embodiment of the present invention.

FIG. 3 shows a block diagram of a server apparatus according to an exemplary embodiment of the present invention.

FIG. 4 shows an example of a communication network according to an exemplary embodiment of the present invention.

FIG. 5 shows two frames in a timing adaptation diagram for a better understanding of the present invention.

FIG. 6 shows a method for synchronizing according to an exemplary embodiment of the present invention.

### DETAILED DESCRIPTION

The illustration in the drawings is schematic. In different drawings, similar or identical elements are provided with the same reference numerals.

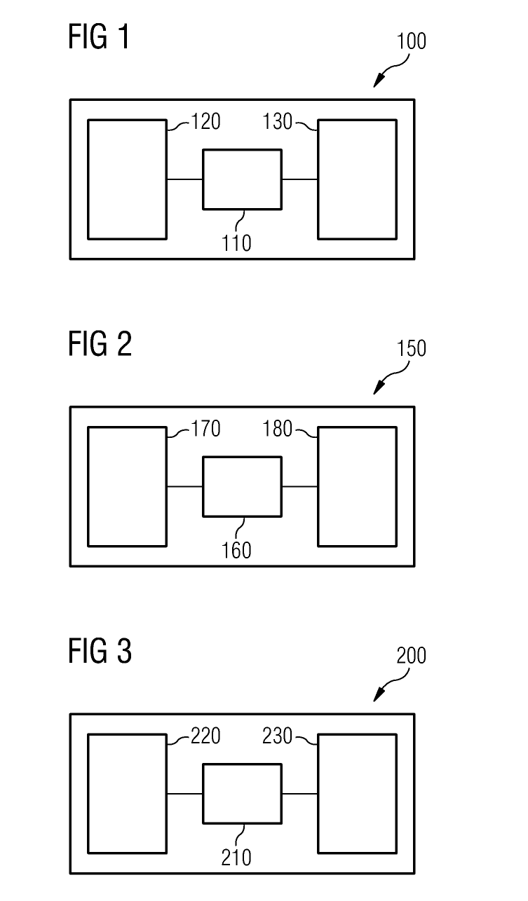

FIG. 1 shows a base station apparatus 100 comprising a synchronization device 110, a receiving device 120 and a sending device 130. Here the receiving device 120 and the sending device 130 are separated devices. It may also be possible that the base station apparatus 100 may comprise a combined receiving and sending device, meaning that only one device may be provided for receiving and sending purpose. In FIG. 1 the synchronization device 110 may be connected with the receiving device 120. The synchronization device 110 may also be connected with the sending device 130.

The synchronization device 110 of FIG. 1 may provide a synchronization measure. Upon request from another apparatus or another device the synchronization device may provide the synchronization measure to the other apparatus or the other device.

FIG. 2 shows a user equipment apparatus 150, which may be a mobile, a mobile apparatus, a mobile station, a mobile terminal, a laptop, a PDA (Personal Digital Assistant) or a mobile phone. The user equipment apparatus 150 may comprise an evaluation device 160, a receiving device 170 and a sending device 180. The evaluation device 160 may be connected with the receiving device 170. The evaluation device 160 may also be connected with the sending device 180.

The user equipment apparatus 150 may receive with the receiver device 170 several signals, which may be sent over the air. The evaluation device 160 may calculate from different received signals a time shift between different base stations. This means that the user equipment apparatus may be used as a measurement device in order to determine a time shift between signals sent by different base station apparatus.

FIG. 3 shows a server apparatus 200, which is in this exemplary embodiment a SON server. The server apparatus may comprise a storage device 210, a receiving device 220 and a sending device 230. The storage device 210 may be connected with the receiving device 220. The storage device 210 may also be connected with the sending device 230.

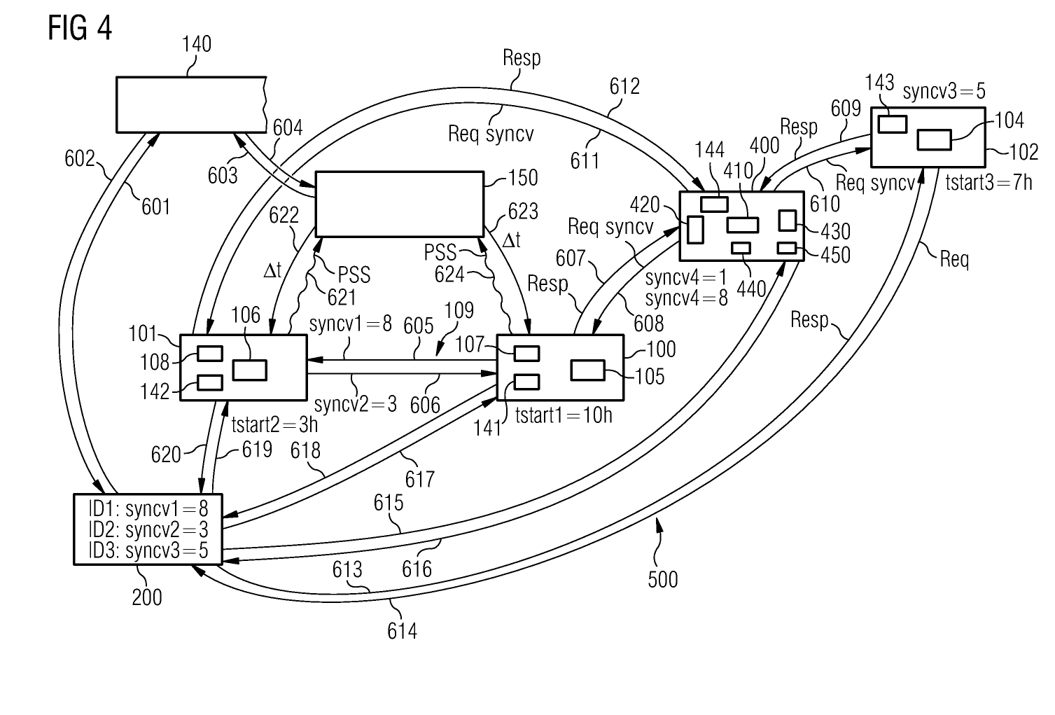

FIG. 4 shows a telecommunication network 500 with a first base station apparatus 100, a second base station apparatus 101 and a third base station apparatus 102. The telecommunication network further may comprise a user equipment apparatus 150, which may be here a mobile phone and a server apparatus 200. It may also be provided a broadcast channel 140 inside the area of a base station 100, 101, 102, etc.

In this example the first base station apparatus 100 may be operating since 10 hours without interruption in the telecommunication network 500, which is shown in FIG. 4 as tstart1=10 h. The second base station apparatus 102 may be operating since 3 hours without interruption, which is shown in the FIG. 4 as tstart2=3 h. The third base station apparatus 102 may be operating since 7 hours without interruption, which is shown in FIG. 4 as tstart3=7 h.

The synchronization measure, shown in FIG. 4 as syncv, may be expressed for example in a range from 1 to 10, wherein in this embodiment a synchronization measure of 1 is the lowest measure and a measure of 10 is the highest synchronization measure. Here the first base station apparatus 100 may have a synchronization measure of syncv1=8, the second base station apparatus 101 may have a synchronization measure of syncv2=3 and the third base station apparatus 102 may have a synchronization measure of syncv3=5.

In this example, the first base station apparatus 100 may have the best synchronization measure compared to the other base station apparatuses 101 and 102. In this comparison the third base station may have a medium synchronization measure and the second base station may have a low synchronization measure. The expressions “high”, “low” and “medium” in relation to the synchronization measure may be determined in relation to the available range of the synchronization measure as given by a self-determined definition of the network. In this example of FIG. 4, inside the network synchronization measures may be available in a range from 1 to 10, wherein the value of 1 may represent the lowest synchronization quality and wherein the value of 10 may represent the highest synchronization quality. In this respect the first base station with syncv1=8 may have a high synchronization quality, the second base station with syncv2=3 may have a low synchronization quality and the third base station with syncv3=5 may have a medium synchronization quality.

The synchronization measure may be characteristic for each base station apparatus 100, 101, 102, which may be expressed by the index “1”, “2” and “3” of the synchronization measure syncv. Furthermore, the synchronization measure may change in time. Moreover, the synchronization measure may depend on different factors. One factor may be the operation time of a base station apparatus. Another factor may be a time difference related to the starting point of transmitted frames of a plurality of base station apparatuses.

The synchronization measure may vary in time dependent on adjustment procedures and/or on operation time. In the present embodiment the synchronization measure of the first base station apparatus 100 and the second base station apparatus 101, respectively depend on adjustment procedures while the synchronization measure of the third base station apparatus 102 depend on operation time.

In the following the factor of a time difference is described. A time difference value may be used for adjusting the transmission of the starting point of frames of the respective base station apparatus. In this embodiment the synchronization measures of the first base station apparatus 100 and the second base station apparatus 101 may be based on a time adjustment procedure initiated by the user equipment 150.

This may mean that the first base station apparatus 100 and the second base station apparatus 101 may gain their synchronization measure from different sources. The third base station apparatus 102 may count its operation time tstart3. The higher the operating time without interruption the higher might be the synchronization measure. In this embodiment an operation time of 7 hours may be represented in a synchronization measure for the third base station apparatus 102 of syncv3=5.

The first base station apparatus 100 and the second base station apparatus may receive their synchronization measure from the user equipment 150. Therefore the user equipment apparatus may measure a time difference of transmitted signals, transmitted by the first base station apparatus 100 and by the second base station apparatus 101, respectively. In the evaluation unit 160 of the user equipment apparatus 150 a time difference may be determined. With the sending unit 180 of the user equipment apparatus 150 this time difference may be sent to the first base station apparatus 100 as well as to the second base station apparatus 101 as delta t, which is shown in FIG. 4. In the present embodiment frames of transmitted signals may be synchronized. Therefore the user equipment unit 160 may evaluate starting points of frames received by the first base station apparatus 100 and the second base station apparatus 101.

In the following further details for a synchronization of transmitted frames of the first base station apparatus 100 and the second base station apparatus 101 may be described in order to prepare further procedural steps in relation to the synchronization measure.

In this context “decentralized synchronization” means that there may be no central apparatus that may inform other apparatuses regarding absolute time setting like the centralized DCF77 transmitter in Mainflingen (Germany) that informs radio controlled clocks regarding their absolute time setting. With decentralized synchronization each apparatus may exchange with other apparatuses time information and may correct the information until all apparatuses may have the same time information.

The idea of a decentralized synchronization scheme may be to achieve a local common frame timing by a mutual adaptation of the individual frame timing. The synchronization procedure may consist of two steps:

In the first step the user equipment 150 may receive a synchronization signal sent by the first base station apparatus 100 and a further synchronization signal by the second base station apparatus 101, respectively. The synchronization signal may be a PSS and or a SSS. In the exemplary embodiment shown in FIG. 4 a PSS is utilized.

In the first step the frame timing of the received LTE primary and secondary synchronization signal (PSS, SSS) may be acquired. In the second step, the own frame timing may be adapted according to the observed time difference to the received neighbour base station. This may mean that in this example the frame timing of the first base station apparatus 100 may be adapted to the second base station apparatus 101 which may be located in the neighbourhood of the first base station apparatus 100.

For acquisition of received LTE frame timing difference a correlation based scheme may be used. In detail for LTE or LTE-A, a correlation to the PSS and SSS may be done.

Further, if over the air synchronisation may be done and propagation delay is neglected, the user equipments connected or camping on a base station Xₖ may be utilized to measure the timing difference of PSS and/or SSS to a received neighbour base station Xᵢ and the evaluation may be done by determining the time difference Δtᵢₖ between the correlation maxima related to the own and the neighbour base station PSS and SSS signal.

In the embodiment shown in FIG. 4 the user equipment apparatus 150 may be connected to the first base station 100 (base station Xₖ) and the neighbour base station may be the second base station apparatus 101 (base station Xᵢ). With the help of the evaluation unit 160 of the user equipment apparatus 150 a time difference between frames of the first base station apparatus 100 and the second base station apparatus 101 may be performed.

Then at the end of the timing difference measurement and acquisition phase, each base station Xₖ may adapt its own timing tₖ according to

t_{k,new}=t_{k,old}+w×Δtᵢₖ

where the parameter w denotes a weighting factor (w<1) and the value Δtᵢₖ may be measured at the UE and signalled to the eNB, here the first base station apparatus 100 and the second base station apparatus 101. In FIG. 5 t_{k,old} may be indicated by numeral 703, t_{k,new} may be indicated by numeral 704 and w×Δtᵢₖ may be indicated by numeral 705.

In the present embodiment the first base station apparatus 100 may adapt its frame in the time domain according to the received timing difference delta t or Δt sent by the user equipment apparatus 150 over the sending unit 180. The same may be performed by the second base station apparatus 102 in respect to the received timing difference delta t sent by the user equipment apparatus 150.

FIG. 5 shows a timing adaptation 700 of the first base station apparatus 100, here base station Xₖ. FIG. 5 may show a time axis. In FIG. 5 frame n may be indicated by numeral 701. Within frame n UEs connected or camping on base station Xₖ may measure a time offset of Δtᵢₖ, meaning a time difference value, with respect to base station Xᵢ and may transmit the information regarding Δtᵢₖ either by layer 1 signalling (this is similar to fast power control signalling in LTE) or higher layer signalling (layer 2 measurement reports) to the base station Xₖ. With other words, the user equipment apparatus 150, which may be connected to the first base station apparatus 100 (base station Xₖ), may measure a time difference with respect to the second base station apparatus 101 (base station Xi). The transmitted time difference may be received by the receiving unit 120 of the first base station apparatus 100.

According to the above-mentioned equation Xₖ may shift the start position of the next frame n+1, by w×Δtᵢₖ the first base station may amend the starting point of the following frame for transmitting. In FIG. 5 frame n+1 may be indicated by numeral 702 and w×Δtᵢₖ may be indicated by numeral 705. Since all base stations in the neighbourhood may participate in the mutual synchronization procedure, a locally common frame timing may be achieved. In the present embodiment of the invention the first base station apparatus 100 and the second base station apparatus 101 may be synchronized according to this method.

The third base station apparatus 102 may follow a different method for synchronization to relation the other base station apparatuses in the telecommunication network. This further method may be performed because the third base station apparatus may not support the frame synchronization in the way described above. Also other reasons may occur for the further method performed by the third base station apparatus 102.

In order to be synchronized with the other neighbour base stations, the first base station apparatus 100 and the second base station apparatus 101, the third base station apparatus 102 may use an internal operation time counter 104. The operation time of a base station may also be utilized for the determination of the synchronization value.

In this example also the first base station apparatus 100 and the second base station apparatus 101 may comprise such an internal operation time counter 105, 106, respectively. In contrast to the third base station apparatus 102, the counters 105 and 106 of the other base station apparatuses 100 and 101, respectively, are not utilized for synchronization purpose, but may be used for other purpose. With a switching device 107, 108 in the first base station apparatus 100 and in the second base station apparatus 101, respectively, the method utilized for synchronization by using a synchronization measure may be chosen.

The range of the synchronization measure of the third base station 102 may be identical with the range of the synchronization measure of the first base station apparatus 100 and as well with the second base station apparatus 101, which is in this example a range from 1 to 10. This may mean that all three base station apparatuses 100, 101, 102 may utilize the same range of synchronization measure of 1 to 10, wherein the value of 10 may represent the best synchronization performance of a single base station apparatus. As a consequence, all three synchronization measures of the three base station apparatus 100, 101, 102 may be comparable to each other, although the different synchronization measures syncv1, syncv2, syncv3 may originate from different methods performed.

It may also be possible to combine both methods for determining a synchronization factor. Therefore one single synchronization measure may depend on the operation time and also on the timing difference received by a user equipment apparatus.

It may also be possible that according to both methods two independent synchronization measures may be determined for one single base station apparatus. In a further step there may be performed a selection among the first and the second synchronization measure of that base station apparatus. For the selection further characteristics of the base station apparatus or other factors may be relevant.

In the telecommunication network of FIG. 4 the server apparatus 200 may be a SON server, which may store in its storing device 210 a table of identifiers, for example a name, of all base stations in the network, here of base station apparatus 100, 101 and 102. Each base station apparatus may use a unique identification number inside the network, for example ID 1, ID 2, ID 3 for the first base station apparatus 100, the second base station apparatus 101 and the third base station apparatus 102, respectively. With this identification number a base station may be identified in respect to its local place and further characteristics of the respective base station apparatus. The identifiers of each base station apparatus may be stored together with the synchronization measure of that base station in a table of the server 200, as schematically shown in FIG. 4.

In the present embodiment the SON server 200 may store the synchronization value of syncv1=8 in relation to the first base station apparatus 100 and its identification ID 1, the synchronization value of syncv2=3 in relation to the second base station apparatus 101 and its identification ID 2 and the synchronization value of syncv3=5 in relation to the third base station apparatus 102 and its identification ID 3. These synchronization measures may be stored within one table which may change in time, because it may be timely updated, caused by several synchronization procedures taking place in the network. This update may be performed by communication between the SON server apparatus 200 and each of the base station apparatus 100, 101, 102, respectively, as indicated by arrows in FIG. 4. The communications may be performed over an air interface, respectively. Since the synchronization measure may be a dynamic measure which may change timely, updating the data inside the stored table of the SON server apparatus 200 may be done periodically.

In the telecommunication network 500 there may also be provided a communication between different base station apparatus, as also indicated by arrows in FIG. 4. In the present embodiment the first base station 100 and the second base station 101 are connected over a cable connection 109. This connection may be a standardized interface, for example an X2 interface.

In the telecommunication network 500 of FIG. 4 the broadcast channel 140 may also provide several synchronization measures of different base station apparatuses 100, 101, 102 of the network 500. The broadcast channel 140 may be a part of a base station. In FIG. 4 each base station apparatus 100, 101, 102, 400 may comprise an own broadcast channel, respectively. Thus, different broadcast channels of different base station apparatuses may comprise different information. Furthermore, each base station apparatus 100, 101, 102, 400 may comprise a broadcast channel device 141, 142, 143, respectively. Therefore each broadcast device 141, 142, 143 of a base station apparatus 100, 101, 102, 400 may provide a broadcast channel. The broadcast channel 140 in FIG. 4 may be a schematic drawing of the different broadcast channels of the base station apparatuses 100, 101, 102, 400. Thus, the broadcast channel 140 may represent a summary of broadcast channels provided by the different base station apparatuses 100, 101, 102, 400. Each base station apparatus may provide a part of the broadcast channel 140.

The user equipment 150 may utilize the information of the broadcast channel 140 in order to receive information of several base station apparatuses 100, 101, 102, 400. This information may be the synchronization value of a certain base station apparatus or of different base station apparatuses 100, 101, 102, 400.

The server apparatus 200 may communicate with the broadcast channel 140, which is indicated in FIG. 4 by communication connections 601 and 601. The communication connection 601 may indicate a communication from the server 200 to the broadcast channel 140 and the communication connection 602 may indicate a communication from the broadcast channel 140 to the server 200.

The user equipment apparatus 150 may also communicate with the broadcast channel 140, which is indicated in FIG. 4 by communication connections 603 and 604. The communication connection 603 may indicate a communication from the user equipment apparatus 150 to the broadcast channel 140 and the communication connection 604 may indicate a communication from the broadcast channel 140 to the user equipment apparatus 150.

The invention may provide a solution that dependent on the time a base station is in operation and/or the received absolute values of Δtᵢₖ may change in the past, the synchronization stability value (base station synchronisation class) may be dynamically increased. The synchronization stability value or base station synchronisation class may be a property of the base station. And then if Δtᵢₖ values received from UEs may be getting smaller and smaller the synchronization of a base station may be considered to be more and more stable since timing changes (step 2) are getting smaller and smaller.

Via network signalling on X2 or S1 interface the dynamic synchronisation values may be exchanged between base stations. For example a new base station may request the dynamic synchronisation value for a neighbour base station with a specific physical base station ID and then may consider only very stable neighbour nodes in above described decentralized synchronization procedure. And therefore base station may configure UEs only to utilize most stable neighbours. This may be also advantageous in case of the insertion of a new network node. Then with this dynamic synchronization class concept the new network node may be synchronized to the time of the running and stable network and not induce a new round of overall synchronization.

In the following a situation will be explained when a non-synchronized base station apparatus 400 may be synchronized inside the telecommunication network 500. The non-synchronized base station apparatus is a new node B in the present network 500. The new base station apparatus 500 may comprise similar or identical devices like the other base station apparatus 100, 101, 102, e.g. a synchronization device 410, a receiving device 420 and a sending device 430. Furthermore, the new base station 400 may also comprise an operation time counter 440, which may be set to zero, because the new base station apparatus 400 may be not installed inside the network before or it may also be possible that the new base station apparatus 400 had an operation interruption and may restart its service inside the network 500. This value of operation time may represent a very low synchronization measure, here the value of 1. With other words, no synchronization at all may be performed so far.

When entering in the network 500 the new base station apparatus 400 may be synchronized. In a situation without using a synchronization value the new base station apparatus 500 may disturb the already well synchronized neighbor base station apparatus 100, 101 and 102. Thus, the well synchronized neighbor base station apparatuses may loose their quality of synchronization, since the base station apparatus may adapt their time adjustments to the new base station apparatus 400, which may increase the already reached small timing difference between the synchronized base station apparatus. In the present embodiment of FIG. 4 the first base station apparatus 100 and the second base station apparatus 101, which may be adjusted by time framing may loose their synchronization to each other.

In order to avoid such a situation the new non-synchronized base station apparatus 400 may request via air signaling and a request message “Req_syncv” the synchronization measure of its neighbor base station apparatus 100, 101 and 102, respectively. The new base station apparatus 400 may receive a message “Resp” from the neighbor base station apparatuses, respectively. In a synchronization device 450 of the new base station apparatus 400 this three synchronization measures may be stored and may also be compared to each other. After performing such a comparison of the synchronization measures of each requested base station apparatus 100, 101 and 102, the synchronization device 450 may determine a base station apparatus with the best synchronization measure. In this case the new base station apparatus 400 may also be provided with the range of synchronization values of the network 500, which is here a range from 1 to 10. The new base station apparatus 400 may also be provided with the meaning of the lowest and the highest value of the synchronization measure. Then the new base station apparatus 400 may evaluate the value 1 for a lowest synchronization quality and the value of 10 for the highest synchronization quality of a neighbor base station apparatus operating in the network 500. This information may also be utilized for the own synchronization measure of the new base station apparatus 400 for the subsequent operation in the network 500.

After receiving the synchronization measures of 8, 3 and 5, respectively, the new base station apparatus 400 may select the highest available synchronization measure of a neighbor base station apparatus. The highest available synchronization measure may be here the value of 8 of the first base station apparatus 100. Therefore the new base station apparatus 400, which not synchronized yet, may select the neighbor base station apparatus 100 in order to initiate a synchronization process with this first base station apparatus 100. This means that the new base station apparatus 400 may start with a relative high value of synchronization measure, which is here 8. This may avoid any further synchronization effort of the second base station apparatus 101 and the third base station apparatus 102. These both apparatus 101 and 102 may not be involved in the synchronization process of the new base station apparatus and may therefore avoid decreasing their synchronization measure, respectively. Also the first base station apparatus 100, which represents a high synchronization measure of 8 may not decrease this measure when the measure may be used for a synchronization process of the new base station apparatus 400.

It may also be possible, that the new base station apparatus 400 may request with a request message “Req” the server apparatus 200 in order to receive all current synchronization measures of its neighbor base stations 100, 101, 102, as indicated in FIG. 4. Furthermore, it may also be possible after sending a request “Req” to the server apparatus 200 by the new base station apparatus 400, that the server apparatus 200 may evaluate the request and may compare the synchronization measures in its stored table of the requested base station apparatus 100, 101 and 102. Then the server 200 may send back to the requesting new base station apparatus 400 the identification of the base station apparatuses with a high synchronization measure.

Since all apparatuses in the network 500 may communicate with each other and furthermore with the server apparatus 200 and also receiving broadcast signaling from the broadcast control channel 140, further solutions to receive a synchronization measure of other base station apparatus may be possible. A communication may be provided by communication connections 605, 606, 607, 608, 609, 610, 611, 612, respectively, between base station apparatuses. Furthermore a communication may be provided by communication connections 613, 614, 615, 616, 617, 618, 619, 620, 621, 622, 623, 624, respectively. Further communication may also be possible which are not indicated by arrows in FIG. 4, for example a communication between the user equipment 150 and the server 200. Thus, each apparatus 100, 101, 102, 150, 200, 400, may be connected over an air interface and/or over a cable with a further apparatus 100, 101, 102, 150, 200, 400, and the broadcast channel 140.

It may also be possible for a user equipment apparatus 150 to utilize more than two base station apparatus for determining a timing difference and sending this timing difference to them. This may also be done after synchronizing the new base station apparatus 400. In this case a timing difference may be sent to the first base station apparatus 100, to the second base station apparatus 101 and to the new base station apparatus 400.

Moreover, one or a plurality of synchronization measures may be stored on a readable medium. The readable medium may be a hard disk, a memory card, a CD, DVD, USB stick or the like. This readable medium may be readable by the base station apparatuses 100, 101, 102, 400, the server apparatus 200, the user equipment apparatus 150 or other apparatuses and/or devices within the network.

In summary this invention provides several apparatuses and a method for decentralized synchronization with dynamic synchronization stability measures.

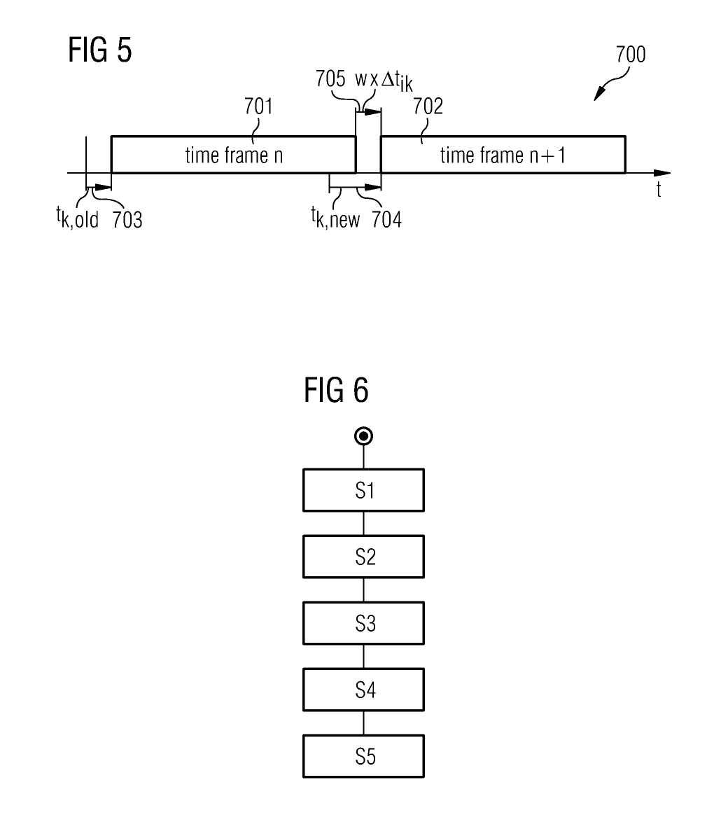

FIG. 6 shows a method for synchronizing a non-synchronized apparatus or for synchronizing an asynchronous apparatus according to the present invention. The method may be performed for synchronizing a non-synchronized apparatus with a first apparatus and a second apparatus. The non-synchronized apparatus may be the new base station apparatus 400 of FIG. 4. The first apparatus may be the first base station 100 and the second apparatus may be the second base station 101 as shown in FIG. 4.

In step S1 a first synchronization measure syncv1 may be received from the first base station 100. In step S2 a second synchronization measure syncv2 may be received from the second base station 101. Step 1 and step 2 may be performed in a subsequent way. It may also be possible of receiving the first synchronization measure and the second synchronization measure simultaneously. In step S3 the first synchronization measure syncv1 and the second synchronization measure syncv2 may be compared. In step S4 at least one synchronization measure may be selected from the group of the synchronization measures syncv1 and syncv2. The selection of the present example may be syncv1, because syncv1 may represent a more stable synchronization characteristic compared to syncv2. This may be the result, because in the network 500 a range of 1 to 10 is provided for all synchronization measures of different base station apparatuses, wherein the value of 1 represents a lower synchronization quality than the value of as maximum value for synchronization measure. After selecting syncv1 as highest available synchronization measure in the network, the new base station apparatus 400 may be synchronized with the first base station 100 in step S4.

In a further step S5 the first synchronization measure of the first base station apparatus 100 which may also be the new synchronization measure syncv4 of the new base station apparatus 400 may be sent to the broadcasting channel 140 by the new base station 400.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### Acronyms and Terminology

### 3GPP Third Generation Partnership Project

### BS Base Station

### CD Compact Disc

### DVD Digital Video Disc

eNB enhanced Node B (LTE base station)

### E-UTRAN Evolved UTRAN

### FDD Frequency Division Duplex

### IE Information Element

### ISD Inter Side Distance

### LTE Long Term Evolution

### LTE-A Long Term Evolution Advanced

### MBMS Multimedia Broadcast and Messaging Service

### Node B Node B

### PSS Primary Synchronization Signal

### RAN Radio Access Network

S1 Interface Interface between eNB and mobile to fixed network gateway

### SON Self Organizing Enabled Networks

### SSS Secondary Synchronization Signal

### TDD Time Division Duplex

### UE User Equipment

### UL Uplink

### USB Universal Serial Bus

### UTRAN Universal Terrestrial Radio Access Network

X2 Interface Interface for eNB to eNB communication

1. Base station apparatus comprising
a synchronization device for generating a synchronization measure, wherein the synchronization measure represents a quality measure of synchronization for the base station apparatus;
a sending device for sending the synchronization measure to further devices in a communication network.

2. Base station apparatus according to claim 1, wherein the synchronization measure is at least one value selected from the group of values consisting of a time duration value, an on-time value, an absolute value, a relative value and a normalized value.

3. Base station apparatus according to claim 1, comprising further a receiving unit for receiving a time adjustment value, wherein the time synchronization value is determinable from the received time adjustment value.

4. Base station apparatus according to claim 1, further comprising a threshold value.

5. Base station apparatus according to claim 1, wherein the synchronization measure is exchangeable between the base station apparatus and a further apparatus in the network.

6. Base station apparatus according to claim 1 wherein the base station apparatus can provide an information element comprising the synchronization measure.

7. User equipment apparatus comprising a receiving device for receiving a first signal from a first device and a second signal from a second device;
an evaluation device for evaluating a time difference value between the first signal and the second signal;
a sending device for sending the time difference value to an apparatus; wherein the time difference value allows to determine a synchronization measure of the apparatus.

8. User equipment according to claim 7, wherein the evaluation device provides the synchronization measure.

9. User equipment according to claim 7, further comprising a threshold value.

10. Server apparatus comprising a storage device for storing a first synchronization measure and a second synchronization measure, wherein the first synchronization measure is stored in relation to a first identification of a first apparatus; and wherein the second synchronization measure is stored in relation to a second identification of a second apparatus.

11. Server apparatus according to claim 10, wherein the server apparatus is a self organizing enabled network (SON) server apparatus.

12. Server apparatus according to claim 10, wherein the first synchronization measure and the second synchronization measure can be timely updated.

13. Method for synchronizing a non-synchronized apparatus with a first apparatus and a second apparatus in a communication network, the method comprising:
receiving a first synchronization measure from the first apparatus;
receiving a second synchronization measure from the second apparatus;
comparing the first synchronization measure with the second synchronization measure;
selecting at least one measure from the group of measures consisting of the first synchronization measure and the second synchronization measure such that the selected synchronization measure represents the highest quality of synchronization of the first synchronization measure and the second synchronization measure;
synchronizing the non-synchronized apparatus with that apparatus representing the highest quality of synchronization.

14. Method according to claim 13, further comprising broadcasting at least one measure selected from the group of measures consisting of the first synchronization measure, the second synchronization measure and a third synchronization measure.
